(19) United States
(12) Patent Application Publication
(10) Pub. No.: US 2008/0074048 A1
(43) Pub. Date: Mar. 27, 2008

(54) ELECTROLUMINESCENT DEVICE HAVING A SURFACTANT-COATED CATHODE

(75) Inventors: Kwan-Yue Jen, Kenmore, WA (US); Yu-Hua Niu, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: WASHINGTON, UNIVERSITY OF, Seattle, WA (US)

(21) Appl. No.: 11/754,201

(22) Filed: May 25, 2007

Related U.S. Application Data
(60) Provisional application No. 60/808,920, filed on May 25, 2006.

(51) Int. Cl. H01J 1/62

(52) U.S. Cl. 313/506

(57) ABSTRACT

An electroluminescent device having improved efficiency and stability through the incorporation of a surfactant layer intermediate the cathode and emissive layer.

### CROSS-REFERENCE TO RELATED APPLICATION

This application claims the benefit of U.S. Provisional Application No. 60/808,920, filed May 25, 2006, expressly incorporated herein by reference in its entirety.

### STATEMENT OF GOVERNMENT SUPPORT

This invention was made with government support under Grant Number F49620-01-1-0364, awarded by the Air Force Office of Scientific Research. The government has certain rights in the invention.

### BACKGROUND OF THE INVENTION

Significant attention has been given to organic light-emitting diodes (OLEDs) due to their potential applications in large-area flat-panel displays and low-power-consumption white-light illumination. Efficient and balanced charge injection from both anode and cathode into the electroluminescent (EL) layer is important to achieve high performance OLEDs. The common approach to realizing efficient electron injection is to employ a low-work-function metal as a cathode and then protecting it by depositing a stable metal covering. Low-work-function metals are highly reactive and tend to create detrimental quenching sites at areas near the interface between the EL layer and cathode. The mobile metal ions formed during the cathode evaporation process can also affect the long-term stability of OLED devices. To solve these problems, a layer of ultra-thin insulating compound, such as lithium fluoride or cesium fluoride, has been used as an electron-injection buffer between the EL layer and a high-work-function electrode. Devices fabricated with an electron-injection buffer have been demonstrated with performance equal to, or even exceeding, the performance of devices with low-work-function cathodes.

Improved electron injection at high work-function OLED cathodes has been achieved by using either soluble metal-ion-containing polymers or surfactants. Efficient OLEDs have been fabricated by blending poly(ethylene glycol) (PEG) into EL polymer and using aluminum (a relatively high-work-function metal) as a cathode. By spin-coating a layer of nonionic neutral surfactants on top of an EL polymer layer and using a high-work-function cathode, highly-efficient OLEDs have been achieved.

While surfactant-modified cathodes have shown progress in facilitating the use of high-work-function cathode materials for efficient devices, improvements in electron injection and device stability are still required for commercial OLED applications.

### SUMMARY OF THE INVENTION

In one aspect, the present invention provides an electroluminescent device. In one embodiment, the electroluminescent device has a first electrode, a second electrode, an emissive layer intermediate the first and second electrodes, and a surfactant layer that includes a triblock copolymer, intermediate the second electrode and the emissive layer.

In one embodiment, the triblock copolymer is a poly(propylene glycol)-b-poly(ethylene glycol)-b-poly(propylene glycol) triblock copolymer.

In one embodiment, the triblock copolymer is a poly(ethylene glycol)-b-poly(propylene glycol)-b-poly(ethylene glycol) triblock copolymer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 illustrates a representative electroluminescent device of the invention.

FIG. 2 illustrates a representative electroluminescent device of the invention that includes a hole-injection/transport layer and an electron-injection/transport layer.

FIG. 3 illustrates triblock copolymer surfactants PEP and EPE, useful in representative electroluminescent devices of the invention.

FIG. 4 illustrates electroluminescent compounds useful in electroluminescent devices of the invention.

FIG. 5 illustrates the relative energies of exemplary materials useful in electroluminescent devices of the invention.

FIG. 6 graphically illustrates external quantum efficiency versus current density (a) and brightness versus current density (b) of OLEDs incorporating MEH-PPV with varying cathodes: Al (□), Ca/Al (O) and EPE/Al (Δ).

FIG. 7 graphically illustrates external quantum efficiency versus current density (a) and brightness versus current density (b) of OLEDs incorporating P-PPV with varying cathodes: Al (□), Ca/Al (O) and EPE/Al (Δ).

FIG. 8 graphically illustrates external quantum efficiency versus current density (a) and brightness versus current density (b) of OLEDs incorporating PF-TPA-OXD with varying cathodes: Al (□), Ca/Al (O) and EPE/Al (Δ).

FIG. 9 graphically illustrates OLED devices fabricated using A-only electrodes and EPE-coated Al electrodes.

FIG. 10 graphically illustrates the photocurrent density of P-PPV-based OLEDs, incorporating PEDOT:PSS as an anode-buffer-layer and varying cathodes materials, under illumination of simulated AM1.5, 100 mW/cm².

FIG. 11 graphically illustrates external quantum efficiency versus current density for a fresh-made OLED (□) (structure: ITO/PEDOT:PSS/P-PPV/EPE/Al) and from the same device after 30 days (O).

### DETAILED DESCRIPTION OF THE INVENTION

In one aspect, the present invention provides an electroluminescent (EL) device. In one embodiment, the electroluminescent device has a first electrode, a second electrode, an emissive layer intermediate the first and second electrodes, and a surfactant layer that includes a triblock copolymer, intermediate the second electrode and the emissive layer.

A purpose of triblock copolymers in the present invention is to facilitate electron-injection/transport from the cathode of an electroluminescent device. Representative triblock copolymers include poly(ethylene oxide) (EO) blocks and poly(propylene oxide) (PO) blocks. As used herein, “poly(ethylene glycol)” is used interchangeably with “poly(ethylene oxide),” and “poly(propylene glycol)” is used interchangeable with “poly(propylene oxide).” Example 1 describes representative electroluminescent devices of the invention that include triblock copolymers as surfactant-layers on cathodes. Representative triblock copolymers of the invention have the general formula (EO)ₓ(PO)_{y}(EO)_{z} (“EPE”) or (PO)ₓ(EO)_{y}(PO)_{z} (“PEP”). The number of repeating ethylene oxide or propylene oxide units (x, y, and z) can be varied independently. In one embodiment, x is an integer from about 10 to about 500, y is an integer from about 10 to about 500, and z is an integer from about 10 to about 500. In one embodiment, x=z. Representative triblock copolymers of the invention have a number average molecular weight (Mₙ) from about 1,000 to about 100,000. In one embodiment, triblock copolymers of the invention have a number average molecular weight (Mₙ) from about 1,000 to about 15,000. In one embodiment, triblock copolymers of the invention have a number average molecular weight (Mₙ) from about 15,000 to about 50,000. In one embodiment, triblock copolymers of the invention have a number average molecular weight (Mₙ) from about 50,000 to about 100,000. The higher the Mₙ of a polymer, the lower the concentration needed to form a functioning surfactant layer.

In one embodiment, the triblock copolymer is a poly(propylene glycol)-b-poly(ethylene glycol)-b-poly(propylene glycol) triblock copolymer.

In one embodiment, the triblock copolymer is a poly(ethylene glycol)-b-poly(propylene glycol)-b-poly(ethylene glycol) triblock copolymer. In a representative embodiment of EPE, x=106, y=70, and z=106.

Triblock copolymers are capable of increased solubility when compared to homopolymers. In a representative example, customizing the length of PO and EO segments in EPE or PEP will alter the solubility in solvents used to form films of the triblock copolymer.

The physical properties of the triblock copolymer layer can also be altered based on the relative amounts of each type of block in the copolymer. In a representative example, the glass-transition temperature (T_{g}) of a triblock copolymer can be increased by increasing the amount of PO, which adds rigidity to the polymer, relative to EO. Increasing the amount of PO in a polymer will increase the stability of an electroluminescent device that incorporates the polymer. Additionally, an increase in the overall copolymer molecular weight will increase both T_{g} and device stability.

Any electroluminescent material known to those skilled in the art will be useful in devices of the present invention. In one embodiment, the emissive layer includes an emissive material selected from the group consisting of poly(2-methoxy-5-(2′-ethylhexyloxy)-p-phenylene vinylene) (“MEH-PPV”), polyphenylene vinylene (“PPV”), and poly[(9,9-bis(4-di(4-n-butylphenyl)aminophenyl))]-stat-(9,9-bis(4-(5-(4-tert-butylphenyl)-2-oxadiazolyl)-phenyl))-stat-(9,9-di-n-octyl)fluorene (“PF-TPA-OXD”).

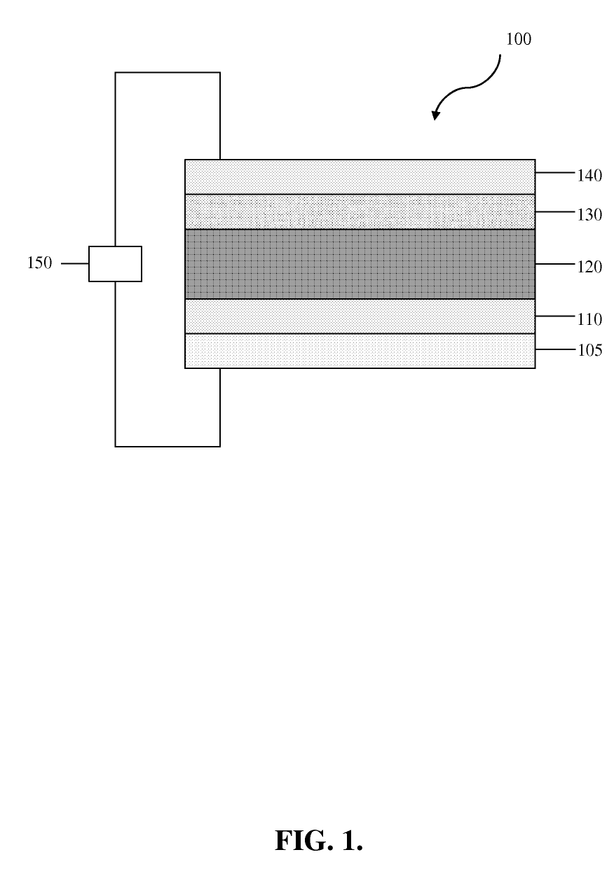

Electroluminescent devices of the invention can be fabricated using well known microelectronic and semiconductor processing techniques known to those skilled in the art. The most common form of electroluminescent devices embodied by the present invention is the organic light-emitting diode (OLED), also called a polymer light-emitting diode (PLED) where a polymer is used as the electroluminescent layer. A typical device 100 is illustrated in FIG. 1 and includes a substrate 105 and a first electrode 110. In one embodiment, the first electrode is an anode. In one embodiment, the first electrode is either indium-tin-oxide (ITO) or fluorine-tin-oxide. Any transparent conductive material will be useful as an anode. Conductive organic films, including conductive plastics and conductive organic/inorganic hybrid composites, are representative examples of transparent conductive materials. On top of the first electrode, electroluminescent film-forming materials in liquid form are deposited, typically by spin coating, drop coating, or another solution-based deposition technique. The film deposition technique forms a solid film that can then be cured at an elevated temperature so as to evaporate any remaining solvent. The product is an electroluminescent film 120. On top of the electroluminescent film, a triblock copolymer surfactant layer 130 is made by a solution-based deposition technique. In one embodiment, the surfactant layer has a thickness of from about 1 nm to about 15 nm. A second electrode 140 is deposited on top of the triblock copolymer surfactant layer. In one embodiment, the second electrode is a cathode. In one embodiment, the second electrode is a high-work-function material. As used herein, the term “high-work-function material” refers to an electrode material with a work function greater than (i.e., more negative than) about −3.5 eV. A representative second electrode is a metallic electrode deposited by an evaporation or sputtering technique. Representative second electrode materials include gold, silver, aluminum, magnesium, calcium, cesium fluoride, lithium fluoride, combinations of the materials (i.e., aluminum-capped CsF), and other electrode materials known to those skilled in the art.

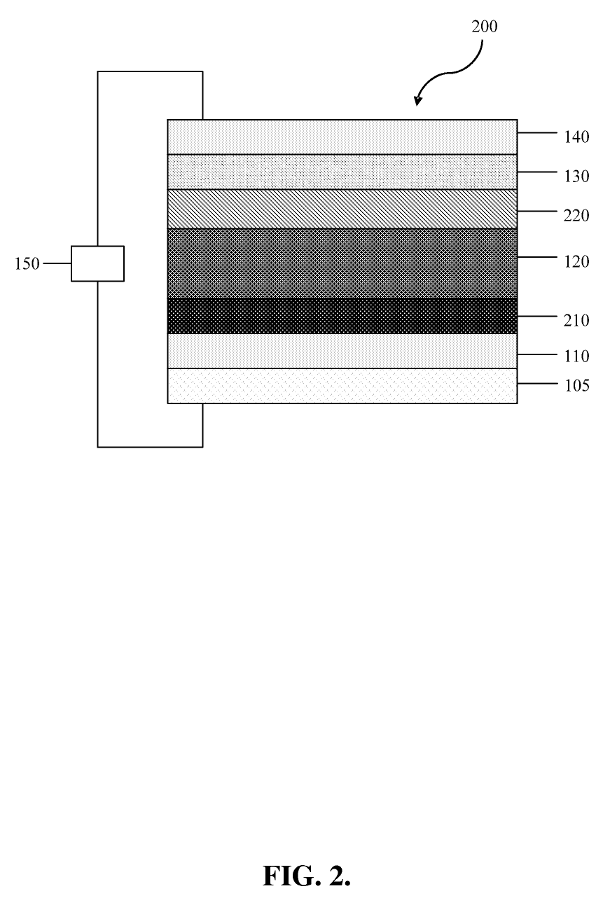

Electroluminescent devices of the invention may also incorporate hole- or electron-transporting materials, or both, into the overall device structure. These charge-transporting materials allow for both efficient injection of charges from the electrodes into the electroluminescent layer and also allow for tuning of the number and location of holes and/or electrons in the device. In addition, the hole-transporting layer can also function as an electron-blocking and exciton-confining layer at the anode side, and the electron-transporting layer can function as a hole-blocking and exciton-confining layer at the cathode side. A complex device 200, as illustrated in FIG. 2, can optionally include a hole-injection/transport layer 210 incorporated into the device to improve charge injection and transport. An electron-injection/transport layer 220 can optionally be inserted intermediate the electroluminescent film and the triblock copolymer surfactant layer. The remaining reference numerals in FIG. 2 identify the same components as in FIG. 1.

In the representative devices described above, the first electrode 110 will act as an anode and will produce holes in the device. To improve the efficiency of hole injection into the device, a hole injection layer 210 may be deposited on the first electrode before the electroluminescent film is formed. A hole-injection layer can be deposited either by a solution-based or vapor-based technique. In one embodiment, the device has a hole-injection buffer layer intermediate the emissive layer and the first electrode. In a further embodiment, the hole-injection buffer layer comprises polyethylene dioxythiophene polystyrene sulfonate (PEDOT:PSS) or polyaniline. To improve the efficiency of electron injection into the device, an electron injection layer 220 may be deposited on the electroluminescent layer before the surfactant layer is formed. An electron-injection layer can be deposited either by a solution-based or vapor-based technique. In one embodiment, the device has an electron-injection buffer layer intermediate the emissive layer and the surfactant layer. The completed device (either 100 or 200) can be operated by attaching the anode and cathode to an electrical power supply 150. When the device is run in forward bias, the electrons and holes produced at the cathode and anode, respectively, will migrate through any charge-transporting layers and will recombine in the EL material.

In one embodiment, electroluminescent devices of the invention also include a substrate 105 adjacent the first or second electrode. Because the representative transparent conductor ITO is traditionally commercially available as a thin-film coating on glass or plastic, representative electroluminescent devices are fabricated using ITO supported on a substrate. In a further embodiment, the substrate is glass or plastic. In a further embodiment, the substrate is adjacent to the first electrode, and the substrate is glass and the first electrode is ITO. From the substrate to the second electrode, the layers of a representative electroluminescent device are: substrate, first electrode (anode), electroluminescent layer, triblock copolymer surfactant, and second electrode (cathode). More complex electroluminescent devices may optionally include a hole-injection/transport layer intermediate the first electrode and the electroluminescent layer and/or an electron-injection/transport layer intermediate the electroluminescent layer and the triblock copolymer surfactant layer.

The following examples are provided for the purpose of illustrating, not limiting, the invention.

### EXAMPLES

### Example 1

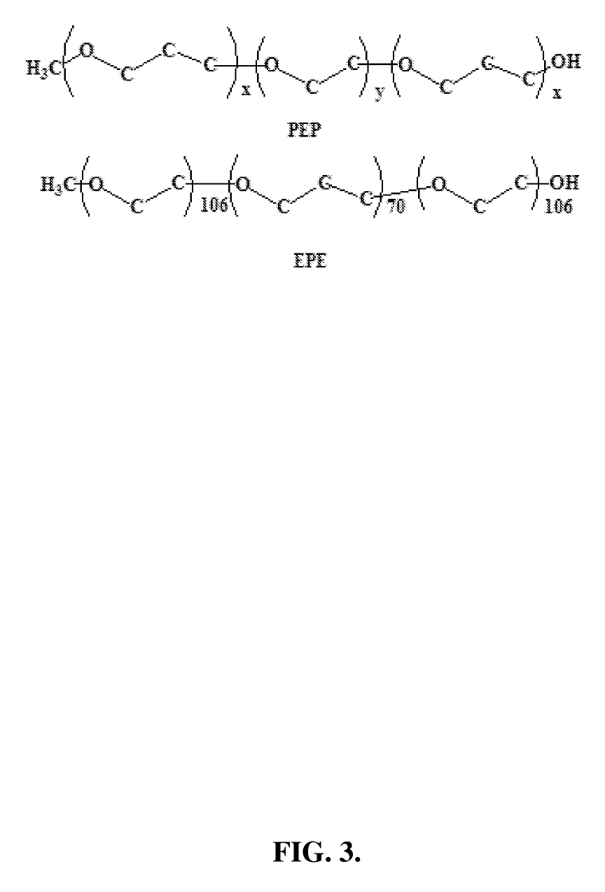

Poly(ethylene glycol) (“PEG”)- or poly(propylene glycol) (“PPG”)-based non-ionic surfactants, polyoxyetholene(6) tridecyl ether (P₆TE), polyoxyetholene(12) tridecyl ether (P₁₂TE), polyethylene glycol hexadecyl ether (BJ76), poly(propylene glycol)(PPG, Mₙ about 1,000), as well as poly(propylene glycol)-b-poly(ethylene glycol)-b-poly(propylene glycol) (PEP, Mₙ about 2,000) were purchased from Aldrich-Sigma. A tri-block copolymer of poly(ethylene oxide) [(EO)ₓ] and poly(propylene oxide) [(PO)_{y}], (EO)₁₀₆(PO)₇₀(EO)₁₀₆ (“EPE”), with molecular weight, Mₙ about 13,000, was provided by BASF Chemicals. As control surfactants, 1-octadecanol and octadecane were purchased from Aldrich-Sigma. Chemical structures of PEP and EPE are illustrated in FIG. 3.

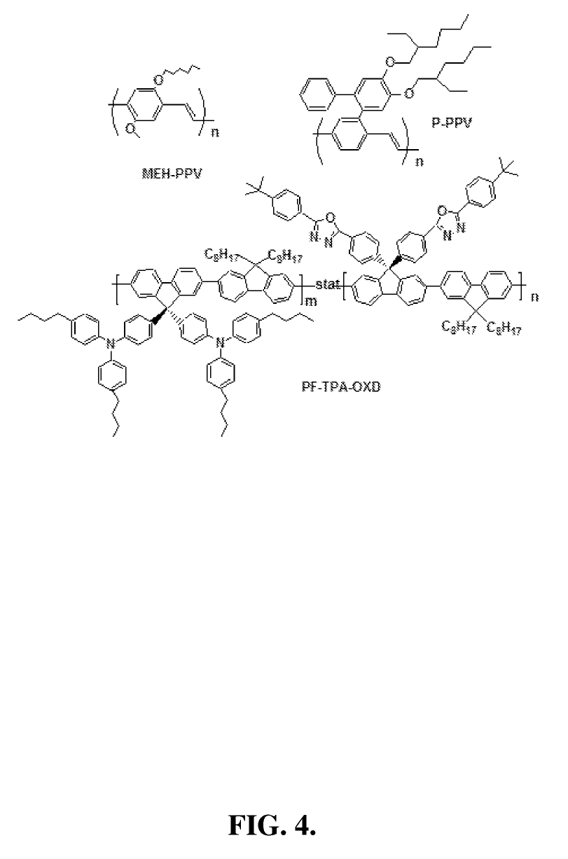

Light-emitting polymers with three representative colors were used: poly(2-methoxy-5-(2′-ethylhexyloxy)-p-phenylene vinylene) (MEH-PPV) (orange-red), poly[2-(2′-phenyl-4′,5′-bis(2″-ethyl-hexyloxy)phenyl)-1,4-phenylenevinylene] (P-PPV) (green) and [poly(9,9-bis(4-di(4-n-butyl-phenyl)aminophenyl))-stat-(9,9-bis(4-(5-(4-tert-butylphenyl)-2-oxadiazolyl)-phenyl))-stat-(9,9-di-n-octyl-fluorene]] (PF-TPA-OXD) (blue). All three emitters were synthesized according to the published procedures and their chemical structures are illustrated in FIG. 4.

OLEDs were fabricated on indium-tin-oxide (ITO) covered glass substrates. A layer of polyethylene dioxythiophene polystyrene sulfonate (PEDOT:PSS, Bayer AG) film (40 nm) was spin coated on pre-cleaned ITO as a hole-injection anode buffer. After the PEDOT:PSS layer was vacuum-dried, the substrates were moved into a glovebox filled with circulated argon. All subsequent device fabrication was performed in an argon environment. A layer of light-emitting polymer, with a nominal thickness of 80 nm, was spin coated on top of the PEDOT:PSS layer. An ultra-thin layer of neutral surfactant (or 1-octadecanol) with a thickness equal to or less than 15 nm was spin coated from a solution of 2-ethoxyethanol. Finally, Al (200 nm) was evaporated under vacuum (<1×10⁻⁶ torr) to form the cathode. For control devices, a layer of Ca (20 nm) was evaporated before the evaporation of Al. On each substrate, five OLEDs with the same size were fabricated simultaneously by defining the cathode via shadow-masking.

OLEDs were encapsulated by cover glasses that were sealed with ultraviolet-cured epoxy. Encapsulated OLEDs were moved out of the glovebox and performance testing was carried out at room temperature. Current-voltage (I-V) characteristics were measured on a Hewlett-Packard 4155B semiconductor parameter analyzer. EL spectra were recorded by a peltier-cooled CCD spectrometer (Instaspec IV, Oriel Co.). Light-power of EL emission was measured using a calibrated silicon photodiode and a Newport 2835-C multifunctional optical meter. Photometric units (cd/m²) were calculated using the forward-output-power together with the EL spectra of the devices based on the emission's Lambertian space distribution.

For photocurrent-voltage measurement, the OLED was exposed to light intensity of 100 mW/cm² from a simulated AM1.5 light source (Oriel Co.). Open-circuit voltages of OLEDs were derived from the zero-current-point on the photocurrent-voltage curves.

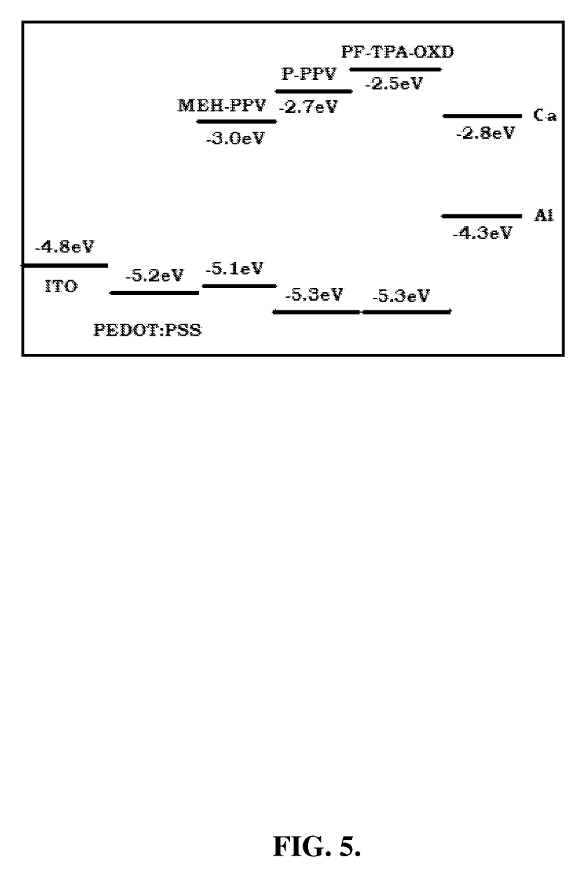

As depicted by the energy level diagram in FIG. 5, the energy level of the highest occupied molecular orbital (HOMO) of PEDOT:PSS is about −5.2 eV and the HOMO level of MEH-PPV is also about −5.1 eV. There is only a negligible hole-injection barrier between PEDOT:PSS and MEH-PPV. On the other hand, the energy level of the lowest unoccupied molecular orbital (LUMO) of MEH-PPV is about −3.0 eV and the work functions of Al and Ca are −4.3 eV and −2.9 eV, respectively. Thus, there exists a large energy-barrier for electron injection when Al is used as a cathode, while there is almost no barrier for injection from a Ca cathode. Due to the difference in electron injection energetics, the external quantum efficiency at 35 mA/cm² differs tremendously between an OLED with Al as a cathode (less than 0.01%) and an OLED with Ca as a cathode (1.39%).

Table 1 presents the external quantum efficiency (ηₑₓₜ) driving voltage (Bias) and brightness (B) of MEH-PPV-based (red-orange) OLEDs incorporating different cathode materials at a current density of about 35 mA/cm². Maximum external quantum efficiency (ηₘₐₓ) and current density (J) for each device is also listed. The results show that, together with an Al cathode, the PEG-based neutral surfactant molecules (P₆TE, P₁₂TE, BJ76), PPG, as well as triblock copolymers PEP and EPE, all improve OLED efficiency versus Al-only devices. The external quantum efficiencies of devices fabricated with a neutral-surfactant are more than two orders of magnitude higher than control devices fabricated with only Al as a cathode and no surfactant. The performance of devices fabricated with a surfactant-coated-cathode equals or surpasses devices fabricated with Ca as cathode.

Because open-circuit voltages can reflect built-in electric field strength, and thus the barrier for electron injection, a measurement of this voltage is useful. Open-circuit voltages were derived from the zero-current points of the photocurrent-voltage under illumination of 100 mW/cm² AM1.5 simulated solar light. As predicted from the work-function difference between Ca and Al, OLEDs with Ca/Al cathodes exhibit an open-circuit voltage (V_{oc}) of 1.52 eV, much larger than that of OLEDs with Al-only cathode-materials (1.26 eV). As demonstrated in the last column of Table 1, by adding a layer of neutral-surfactant, the open-circuit voltages of surfactant-electrode devices were increased to the same level as OLEDs with Ca as a cathode. The change in open-circuit voltage in surfactant devices demonstrates that the electron-injection barrier is reduced to a level similar to Ca while using the much more stable Al as a cathode material.

TABLE 1
Performance of OLEDs having the device structure:
ITO/PEDOT:PSS/MEH-PPV/Cathode.

| | J | Bias* | ηₑₓₜ* | B* | ηₘₐₓ | V_{oc} |
|---|---|---|---|---|---|---|
| Cathode | (mA/cm²) | (V) | (%) | (cd/m²) | (%) | (V) |
| Al | 35.1 | 3.69 | 0.0089 | 4.24 | 0.019 | 1.26 |
| CA/Al | 34.7 | 3.63 | 1.39 | 493 | 1.90 | 1.52 |
| P₆TE/Al | 35.1 | 3.72 | 1.74 | 985 | 2.14 | 1.54 |
| P₁₂TE/Al | 34.2 | 3.50 | 1.70 | 900 | 2.33 | 1.56 |
| BJ76/Al | 34.9 | 4.09 | 1.85 | 928 | 2.21 | 1.42 |
| PPG/Al | 34.9 | 5.17 | 1.24 | 610 | 1.45 | 1.56 |
| PEP/Al | 34.8 | 4.57 | 1.08 | 571 | 1.35 | 1.52 |
| EPE/Al | 34.7 | 3.49 | 1.39 | 757 | 1.79 | 1.58 |
| Octadecanol/Al | 35.4 | 4.31 | 0.258 | 178 | 0.677 | 1.37 |
| Octadecane/Al | 35.6 | 4.75 | 0.047 | 21.3 | 0.053 | 1.16 |

*Corresponding to current density around 35 mA/cm²

To further elucidate the mechanism, octadecane, a pure alkyl chain, and 1-octadecanol, with one hydroxyl end-group, were used as control surfactants for comparison to cathodes coated with triblock copolymer surfactants. As demonstrated in Table 1, the non-PO and non-EO surfactants do not improve device performance over EO and PO devices.

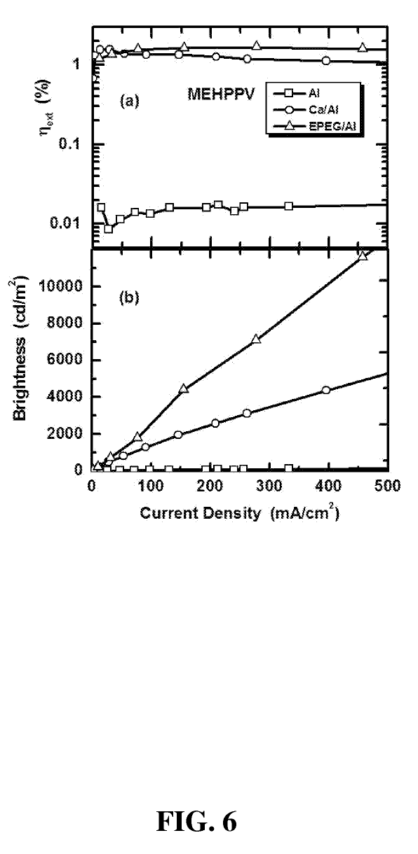

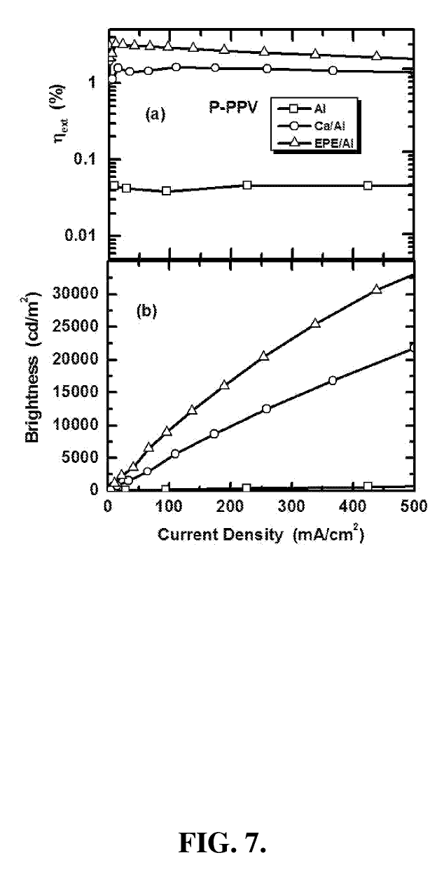

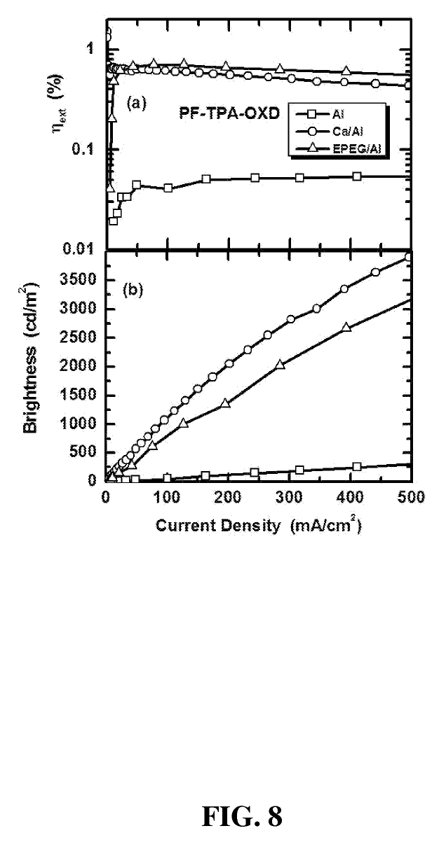

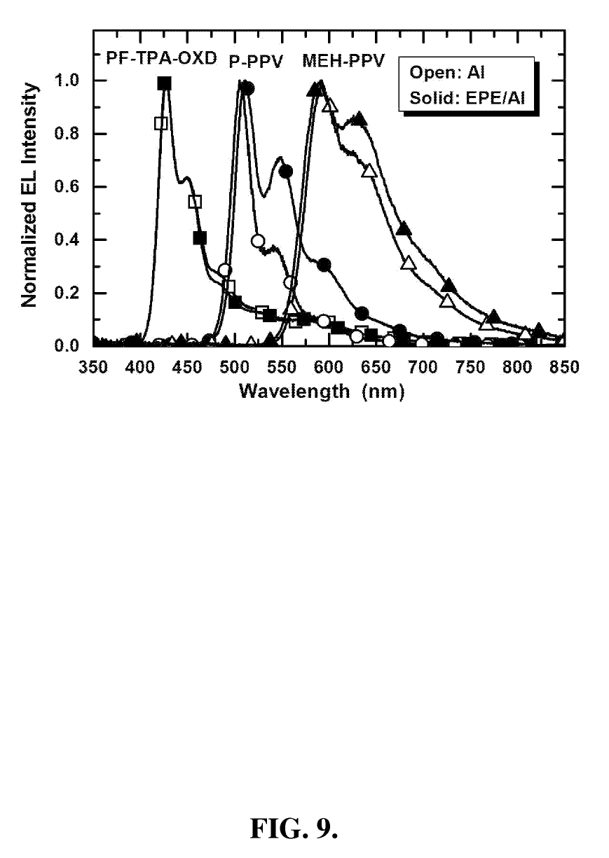

Improvements were also observed for OLEDs with green- and blue-emissions. OLEDs were fabricated based on two light-emitting conjugated polymers, poly(phenylene vinylene) derivatives (PPVs) and polyfluorenes (PFs). Device performance was measured with three different cathode materials: Al, Ca/Al, and neutral surfactant (e.g., EPE)/Al and the device data are summarized in Table 2. External quantum efficiency versus current-density characteristics and brightness versus current-density characteristics of devices are illustrated in FIG. 6 (MEH-PPV), FIG. 7 (P-PPV), and FIG. 8 (PF-TPA-OXD). When a neutral surfactant was used as a cathode buffer-layer on Al, device performance exceeded Ca-cathode devices. The electroluminescent spectra of red, green, and blue OLED devices fabricated with Al-only cathodes compared to EPE-coated Al cathodes are graphically illustrated in FIG. 9.

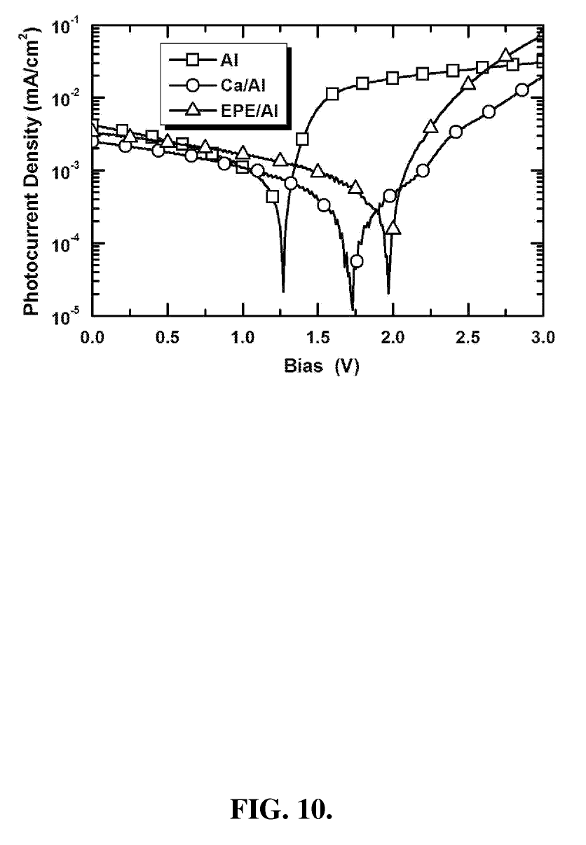

Photocurrent-voltage characteristics (FIG. 10, with P-PPV-based devices) and open-circuit voltage are presented in Table 2.

TABLE 2
Performance of OLEDs with the device structure:
ITO/PEDOT:PSS/EL polymer/Cathode.

| | Cath- | J | Bias* | ηₑₓₜ* | B* | ηₘₐₓ | V_{oc} |
|---|---|---|---|---|---|---|---|
| EL Polymer | ode | (mA/cm²) | (V) | (%) | (cd/m²) | (%) | (V) |
| MEH-PPV | Al | 35.1 | 3.69 | 0.0089 | 4.24 | 0.019 | 1.26 |
| MEH-PPV | Ca/Al | 34.7 | 3.63 | 1.39 | 493 | 1.90 | 1.52 |
| MEH-PPV | EPE/ | 34.7 | 3.49 | 1.39 | 757 | 1.79 | 1.58 |
| | Al | | | | | | |
| P-PPV | Al | 35.1 | 7.03 | 0.0416 | 43.7 | 0.046 | 1.27 |
| P-PPV | Ca/Al | 35.1 | 6.01 | 1.41 | 1526 | 1.62 | 1.73 |
| P-PPV | EPE/ | 34.9 | 5.83 | 3.10 | 3130 | 3.21 | 1.97 |
| | Al | | | | | | |
| PF-TPA- | Al | 35.2 | 10.6 | 0.0369 | 12.9 | 0.053 | 1.55 |
| OXD | | | | | | | |
| PF-TPA- | Ca/Al | 34.8 | 8.23 | 0.616 | 390 | 0.637 | 1.98 |
| OXD | | | | | | | |
| PF-TPA- | EPE/ | 34.9 | 6.79 | 0.579 | 219 | 0.704 | 2.11 |
| OXD | Al | | | | | | |

*Corresponding to a current density of about 35 mA/cm²

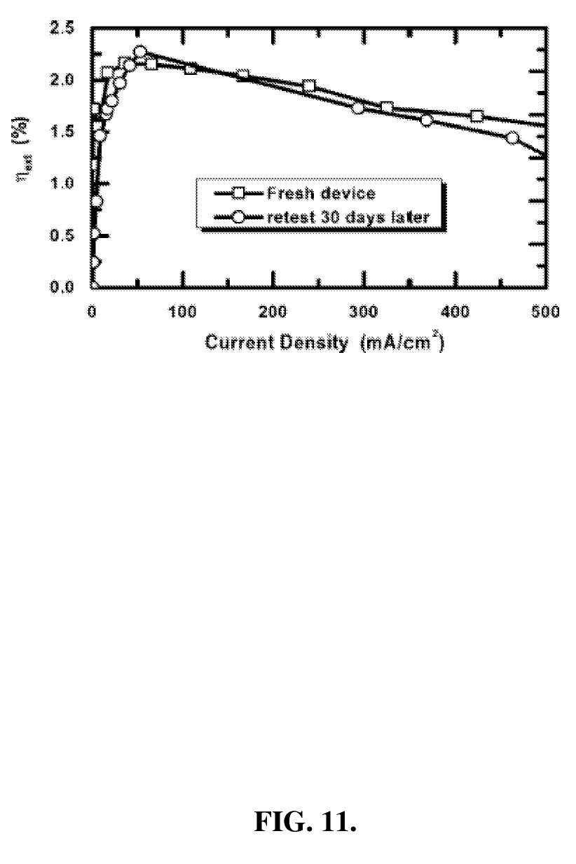

Because the number averaged molecular weights, Mₙ, of the neutral surfactants P₆TE, P₁₂TE, BJ76, PPG and PEP used in this example are in the range of from about 500 to about 2,000, devices made with these low-weight surfactants are less stable than high-weight-surfactant devices. The Mₙ of EPE used in this example is about 13,000. A uniform solid-state thin film can be formed with EPE via spin-coating. The stability of OLEDs fabricated with EPE/Al as a cathode has a very long shelf-life without significant degradation in performance. As illustrated in FIG. 11, with P-PPV as an EL-layer, the external quantum efficiencies of two neighboring OLEDs fabricated on the same ITO substrate, one being tested soon after device fabrication and encapsulation and the other being tested after shelf-storage for 30 days, were almost the same. The combination of a high molecular weight and the triblock copolymer lead to high-stability electroluminescent devices.

The embodiments of the invention in which an exclusive property or privilege is claimed are defined as follows:

1. An electroluminescent device, comprising:
(a) a first electrode;
(b) a second electrode;
(c) an emissive layer intermediate the first and second electrodes; and
(d) a surfactant layer intermediate the second electrode and the emissive layer, wherein the surfactant layer comprises a triblock copolymer.

2. The device of claim 1, wherein the triblock copolymer is a poly(propylene glycol)-b-poly(ethylene glycol)-b-poly(propylene glycol) triblock copolymer.

3. The device of claim 1, wherein the triblock copolymer is a poly(ethylene glycol)-b-poly(propylene glycol)-b-poly(ethylene glycol) triblock copolymer.

4. The device of claim 1, wherein the emissive layer comprises an emissive material selected from the group consisting of poly(2-methoxy-5-(2′-ethylhexyloxy)-p-phenylene vinylene), polyphenylene vinylene, and poly[(9,9-bis(4-di(4-n-butylphenyl)aminophenyl))]-stat-(9,9-bis(4-(5-(4-tert-butylphenyl)-2-oxadiazolyl)-phenyl))-stat-(9,9-di-n-octyl)fluorene.

5. The device of claim 1, wherein the first electrode is an anode.

6. The device of claim 1, wherein the first electrode is an electrode selected from the group consisting of indium-tin-oxide and fluorine-tin-oxide.

7. The device of claim 1, wherein the second electrode is a cathode.

8. The device of claim 1, wherein the second electrode is a high-work-function material.

9. The device of claim 1, wherein the second electrode is an electrode selected from the group consisting of aluminum, silver, and gold.

10. The device of claim 1 further comprising a substrate adjacent the first or second electrode.

11. The device of claim 10, wherein the substrate is glass or plastic.

12. The device of claim 10, wherein the substrate is adjacent to the first electrode, and wherein the substrate is glass and the first electrode is indium-tin-oxide.

13. The device of claim 1 further comprising a hole-injection buffer layer intermediate the emissive layer and the first electrode.

14. The device of claim 13, wherein the hole-injection buffer layer comprises PEDOT:PSS or polyaniline.

15. The device of claim 1, wherein the surfactant layer has a thickness of from about 1 nm to about 15 nm.
